(19) United States
(12) Patent Application Publication
(10) Pub. No.: US 2018/0176325 A1
(43) Pub. Date: Jun. 21, 2018

(54) DATA PRE-FETCHING IN MOBILE NETWORKS

(71) Applicants: Chengchao LIANG, Ottawa (CA); Fei YU, Kanata (CA); Ngoc Dung DAO, Ottawa (CA); Nimal Gamini SENARATH, Ottawa (CA); Hamidreza FARMANBAR, Ottawa (CA)

(72) Inventors: Chengchao LIANG, Ottawa (CA); Fei YU, Kanata (CA); Ngoc Dung DAO, Ottawa (CA); Nimal Gamini SENARATH, Ottawa (CA); Hamidreza FARMANBAR, Ottawa (CA)

(73) Assignee: HUAWEI TECHNOLOGIES CO., LTD., SHENZHEN (CN)

(21) Appl. No.: 15/842,304

(22) Filed: Dec. 14, 2017

Related U.S. Application Data
(60) Provisional application No. 62/434,932, filed on Dec. 15, 2016.

(51) Int. Cl. H04L 29/08; H04L 29/06; G06F 17/30

(52) U.S. Cl. CPC H04L 67/2847; H04W 28/0289; G06F 17/30902; H04L 65/4084

(57) ABSTRACT

A communication system and method for pre-fetching content to be delivered to User Equipment connected to a communication network is provided. The system and method may include at least one network entity operative to evaluate at least one network resource metric measuring an operating condition of the communication network, and operative to send to a UE connected to the network a pre-fetching message to trigger pre-fetching of the content.

### CROSS-REFERENCE TO RELATED APPLICATIONS

This application is based on, and claims benefit of U.S. Provisional Patent Application Ser. No. 62/434,932 filed Dec. 15, 2016, the contents of which is incorporated herein by reference, inclusive of all filed appendices.

### FIELD

The present invention pertains to the field of mobile networks and in particular to a system and method for improving user quality of experience when using a mobile network.

### BACKGROUND

Communication networks provide connectivity between end points such as User Equipment (UE), servers, and other computing devices. The quality of experience (QoE) for users accessing a network is affected by the speed of the network at all points between a user and the end point that is exchanging data with the user's UE. A number of techniques have been implemented in communication networks to improve the network performance, and increase the users' QoE for a given network infrastructure. Two of these techniques are pre-fetching data and caching data to improve network performance.

Pre-fetching data involves transferring data across the network in advance of it being required at the receiving UE. Caching data involves transferring data across the network and storing a copy of cached data logically local to a receiving UE. Caching can be on the end point itself, or at the edge of the network, to manage data demand across the network between the receiving UE and the transmitting end point.

The advantages of pre-fetching and caching include: reduced latency, load balancing backhaul, improved QoE (i.e. avoiding video stalling or pixilation), and reduced peak traffic demand on the network. In general, these techniques improve QoE as the same amount of data is made available to a requesting end point, without the need for the full data set to be transferred across the network fast enough to meet the real-time usage requirements of the requesting UE.

With the development of next generation networks (e.g. 5G networks), the network architecture is split into a user plane handling the data, and a control plane which manages the network functions of network entities across the network. Pre-fetching and caching schemes developed for legacy networks may be insufficient to meet the data traffic requirements of next generation networks.

U.S. patent application Ser. No. 14/606,633 (Publication No. US 2016/0217377) “Systems, Devices and Methods for Distributed Content Interest Predication and Content Discovery”, and International Patent Application No. PCT/IB2015/058796 (Publication No. WO 2016/120694) “Systems, Devices and Methods for Distributed Content Pre-Fetching in Mobile Communication Networks” propose novel methods for pre-fetching based upon predicted content demand by the receiving UE, and a predicted future location of the receiving UE.

By pre-fetching and caching data using predicted content demand and future location, the content data transfer across the network may be managed, reducing peak data traffic demands. With high priority content data transferred in anticipation of an UE's future location, delays in data transfer due to network inefficiencies or traffic congestion are accommodated since the data is pre-located logically proximate to the receiving UE's future location in advance of the content consumption by the receiving UE. In effect, traffic is managed by leaving more time for the content data to transfer across the network to the receiving UE.

While these novel methods are effective at managing data traffic demands generally, they are limited by their reliance on considering only a predicted content demand and a predicted future location of the receiving UE. Accordingly, there is a need for a system and method for pre-fetching data that addresses some of the limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

A communication system and method for pre-fetching content to be delivered to User Equipment connected to a communication network is provided. The system and method may include at least one network entity operative to evaluate at least one network resource metric measuring an operating condition of the communication network, and operative to send to a UE connected to the network a pre-fetching message to trigger pre-fetching of the content.

In an implementation, a communication system is provided that is operative to pre-fetch content for delivery to a UE connected to a communication network, the system comprising: at least one network entity operative to evaluate at least one network resource metric measuring an operating condition of the communication network, and operative to send a pre-fetching message to trigger pre-fetching of the content.

In an aspect, the evaluation comprises considering: Predicted future UE location and handover to connect to the communication network; Predicted future available data bandwidth on communication network data links connecting the UE to a transmitting endpoint providing the content; and, Predicted future buffer/cache status available to receive the pre-fetched data.

In an implementation, a communication system is provided that is operative to pre-fetch content for delivery to a UE connected to a communication network, the system comprising: at least one network entity operative to evaluate at least one network resource metric measuring an operating condition of the communication network, and operative to send to a UE connected to the network a pre-fetching message to trigger pre-fetching of the content.

In an aspect of the present invention, there is provided a method for execution at a control plane function. The method comprises transmitting, towards a user equipment, a prefetching message comprising future data rates; and receiving from the user equipment, a prefetching acknowledgement message. In an embodiment, the control plane function is a Session Management Function. In a further embodiment, the method further comprises, after receiving the prefetching acknowledgement message, transmitting towards at least one of user plane functions and radio access network nodes, instructions to setup a user plane data path.

### BRIEF DESCRIPTION OF THE FIGURES

Further features and advantages of the present invention will become apparent from the following detailed description, taken in combination with the appended drawings, in which:

FIG. 1 is a simplified schematic illustrating an embodiment of pre-fetching data.

FIG. 2 is a simplified network schematic illustrating an embodiment of a system for pre-fetching data.

FIGS. 3A and 3B are process flow charts illustrating embodiments of a data pre-fetching method.

FIGS. 4A and 4B are process flow charts illustrating embodiments of a data pre-fetching method.

FIGS. 5A and 5B are signalling diagrams illustrating embodiments of a system performing a data pre-fetching method.

FIG. 6 is a simplified schematic of a system operative to pre-fetch data.

FIG. 7 is a signalling diagram illustrating an embodiment of a system performing a data pre-fetching method.

FIG. 8 is a simplified schematic of a system operative to pre-fetch data.

FIG. 9 illustrates 3 UE and AN distribution scenarios for an example simulation.

FIG. 10 illustrates simulation results for the 3 scenarios illustrated in FIG. 9.

FIG. 11 illustrates nomenclature used in an example embodiment.

FIG. 12 illustrates relationships for resource allocation scheduling and prefetching based on predicted data, using the nomenclature of FIG. 11.

FIG. 13 illustrates relationships for flow conservation using the nomenclature of FIG. 11.

It will be noted that throughout the appended drawings, like features are identified by like reference numerals.

### DETAILED DESCRIPTION

As used herein, a communication network (or simply a “network”) refers to a collection of communicatively coupled devices which interoperate to facilitate communication between various endpoint devices, such as User Equipment devices. The term “User Equipment” (UE) is used herein for clarity to refer to endpoint devices which are configured to communicate with a network either via fixed line connection, or via radios operating according to a predetermined protocol. UEs include UEs as defined by the 3rd Generation partnership project (3GPP), mobile devices (e.g. wireless handsets) and other connected devices, including Machine-to-Machine (M2M) devices (also referred to as Machine Type Communications (MTC) devices). A mobile device need not be mobile itself, but is a device that can communicate with a network which is capable of providing communication services as the device moves. A network may include, for instance, at least one of a radio access portion which interfaces directly with UEs via radio access and a fixed line portion which interfaces directly with UEs via fixed line access, in combination with a backhaul portion which connects different network devices of the network together. The network may further comprise various virtualized components as will become readily apparent herein. A primary forward looking example of such a network is a Fifth Generation (5G) network. The pre-fetching methods and systems described in this application are applicable to both current 3G and 4G networks, as well as future proposed networks such as 5G networks.

It has been proposed that 5G networks be built with various network technologies that allow for the network to be reconfigured to suit various different needs. These technologies can also allow the network to support network slicing to create different sub-networks with characteristics suited for the needs of the traffic they are designed to support. The network may include a number of computing hardware resources that provide processors and/or allocated processing elements, memory, and storage to support network entities including functions executing on the network, as well as a variety of different network connectivity options connecting the computing resources to each other, and making it possible to provide service to mobile devices. The control plane of the network includes functionality to evaluate data traffic needs in the user plane, and to manage and re-configure the network entities to adjust the available network resources to meet specific Quality of Service (QoS) or QoE requirements.

As described above, pre-fetching and caching data by predicting content demand and future UE location, may be used to manage the transfer of content data transfer across the network to reduce peak data traffic demands. Some users may be static, their future locations could be the same locations. However, the traffic demand in a location can be changed in the future and the network can predict the future demand based on the current user activities. High priority content data may be transferred in anticipation of an UE's future location and cached either at an edge node of the network or on the destination UE. Since data is buffered logically local to the destination UE, delays in data transfer due to network inefficiencies or traffic congestion are accommodated since the data has more time to traverse the network before being required for consumption by the destination UE.

These novel methods are effective at managing data traffic demands generally, and assist in managing traffic demand by extending the time period available for data transfer across the RAN and to a receiving UE. Since the available time period is extended, the process can accommodate periods of network congestion and/or delayed delivery of data and still deliver sufficient data to maintain the QoE at the receiving UE. The methods have a limited range of data transfer scheduling options, as they rely solely on considering predicted content demand and reception location. Accordingly, a decision to transfer data is based on the predicted future need at a predicted location.

The present application provides for a system and methods for pre-fetching and caching data which further take into account network conditions and infrastructure. By adding into consideration network conditions and infrastructure, pre-fetching and caching decisions can be made which are optimized to local conditions within the network. For instance, backhaul links, spectrum availability, cache and buffer size at the local level may be considered and used to direct the pre-fetching and caching of content data to maintain the end user's QoE.

By way of example in a wireless network context, when a receiving UE has a given current location and anticipated future content demand and reception location, the decision to pre-fetch, the size of the content data to be cached, and the cache location may be determined based upon availability of network resources to transfer the content data to the edge of the RAN, the spectrum available to transfer the content data from the edge of the RAN to the receiving UE, as well as cache resources available on the path between the current location and the predicted reception location. Accordingly, if a receiving UE is predicted to be moving towards a low bandwidth location, content data may be pre-fetched and cached at one or more Access Nodes (ANs) that are located on the path between the current location and the predicted low bandwidth location that are able to provide the receiving UE with high bandwidth connections. The specific caching location may further be determined based on available caching resources, as well as network resources available to transfer the data from the source location to possible cache locations within the predicted time window that the receiving UE will be within range of each potential caching location. Thus, the pre-fetched content data may be transferred to the receiving UE over a high bandwidth connection for caching at a selected caching location that is predicted to be on the path between the receiving UE's current location and the area of low-bandwidth connections.

In general, the present application provides for a system and method for pre-fetching data to selected cache locations that serve corresponding ANs based on the predicted movement of receiving UEs and the availability of network resources servicing the locations between the current location of each receiving UE and predicted future locations of that receiving UE.

The decision to pre-fetch and cache data may be triggered by identifying that the receiving UE is either in, or moving to, an area with high bandwidth availability and/or low-cost connectivity such as WiFi APs, small cell ANs, etc.

The decision to pre-fetch and cache data may be triggered by identifying that the receiving UE is predicted to move into a future location with low bandwidth availability and/or high-cost connectivity.

The decision to pre-fetch and cache data may be triggered by identifying that the network resources may be constrained in the future. For instance, building congestion within the network serving the receiving UE's current or predicted future location triggers the pre-fetching of predicted content to avoid transferring data during a period of network congestion.

Incorporating data pre-fetching that includes network resource availability into the pre-fetching decision process has a number of benefits which may be realized by a network operator, including reduced packet latency, enhanced user QoE, and potential cost reductions and efficiency improvements. Network resource based pre-fetching improves network operations as they allow networks to support a higher time average data rate with more stable characteristics (i.e. less data rate fluctuations). As a result, periods of data stalling can be reduced, and re-buffering delay in streamed content such as video is reduced. Furthermore, during periods or network locations with capacity, data may be pre-fetched to reduce data traffic requirements during high demand periods or at network locations that lack capacity. This inherently improves QoE during the high demand period or low bandwidth network locations as less data traffic is demanded at that time, reducing network congestion.

In an implementation, systems and methods for pre-fetching data are provided that adaptively retrieve data to ANs and (or) UEs before actual requests based on at least one of:
QoE requirements, predicted data rate, and mobility patterns of users;
Current or predicted network load and/or costs;
Buffer management (UE and/or RAN); and/or
Network resource allocation.

In an aspect, the systems and methods may include RAN pre-fetching without an application layer in RAN. In the aspect, data pre-fetching requests may be initiated by a UE. Conveniently, RAN caching nodes may cache pre-fetched data that has not been sent (or “requested”) by the UE yet, in anticipation of future UE data demands. The RAN caching helps smooth the backhaul traffic, as well as radio link traffic as content may be delivered to the UE in advance of anticipated demand to avoid dropping streamed data when a radio link becomes congested.

In an implementation, a system may include interaction between network entities such as Access and Mobility Management Function (AMF), Traffic Engineering Function (TEF), Database (DB), and Session Management Function (SMF), and pre-fetching-related functionality enacted by those entities. For instance, in an aspect, the entities may be operative to:
AMF: Predict UE locations and potential handovers that facilitate/trigger pre-fetching
TEF: Predict data rates allocated to UEs in coordination with AMF, SMF, and DB
SMF: Instruct, or assist, UEs, ANs or data centre servers to pre-fetch content in coordination with users, network elements (e.g., ANs, UPF) and transmitting end points (e.g. content servers)
DB: Provide historical data consumption/location metrics to support mobility and content prediction, operator access and mobility management policy, QoS policy, session management policy, and user subscription information.
Video Client at UE: In the case of video content, to select video segments with suitable quality, and to request the selected video segments from the transmitting end point (e.g. a video server) based upon the instructions/assistance provided by the SMF

In an implementation, the TEF can be integrated into SMF, and can be physically implemented in the same computer, or the same data centre.

In an implementation, the AMF and SMF can be integrated in a single function.

In some embodiments at least one of user subscription information and historical data may be stored in a standalone network function. In some such embodiments, the network function storing such data (and in some embodiments acting as the DB) may be one of a Unified Data Management (UDM) function and a Unified Data Repository (UDR) function. In some embodiments (which may overlap with the embodiments described above, policies may be stored and maintained in a Policy Control Function (PCF) or other such network function).

While the present application refers to a User Plane Function (UPF), in some implementations similar functionality may be provided by a Packet Gateway (PGW).

In an implementation, a signalling protocol is provided to support an adaptive pre-fetching method. The protocol permits content to be pulled by the UE/RAN from the transmitting end point (e.g. content server). In some aspects, the protocol may permit the content to be pulled by the UE/RAN from the other RANs where the data is available. In an aspect, the protocol permits content to be pushed by the transmitting end point (e.g. content server) to the UE or RAN (or by the RAN to the UE/other RANs), based upon the instructions/assistance provided by the SMF. In an aspect, the signalling protocol may be implemented to assist with consumption of streamed video data. In an aspect, the signalling protocol may be extended to other services, such as web and FTP.

In an implementation, a pre-fetching system and method is provided that enables data pre-fetching based upon evaluating at least one network resource metric. In an aspect, the pre-fetching system and method is adaptive and determines whether to pre-fetch data based upon, at least in part, current or historical network resource patterns. In an aspect, the at least one network resource metric comprises a future predicted network resource metric. In an aspect, the at least one network resource metric comprises a historical resource metric or pattern of metrics. In an aspect, the at least one network resource metric comprises a combination of a future predicted network resource with a historical resource metric or pattern of metrics.

In an implementation, a pre-fetching system and method is provided that enables data pre-fetching to the edge of a network.

In an aspect, the edge comprises a buffer/cache located at an AN. In an aspect, the AN is selected based upon to store pre-fetched data in advance of a UE connecting to that AN.

In an aspect, the edge comprises a buffer/cache located on the UE. In an aspect, the UE received and stores the pre-fetched data in advance of its need to consume the data. In an aspect, the UE receives and stores the pre-fetched data based upon instructions received from a network entity. In an aspect, the UE receives and stores the pre-fetched data based upon recommendations received from a network entity and the one or more UE-specific conditions. In an aspect, the UE-specific condition may comprise a user selection. In an aspect, the UE-specific condition may comprise a UE buffer status. In an aspect, the network entity evaluates at least one network resource metric to determine that pre-fetching is desirable. In an aspect, the at least one network resource metric may comprise a predicted future network condition. The predicted future network condition may comprise a bandwidth of a data link predicted to connect the UE to the network in the future. The predicted future network condition may comprise a predicted bandwidth of a backhaul link connected to an AN that is predicted to connect the UE to the network in the future.

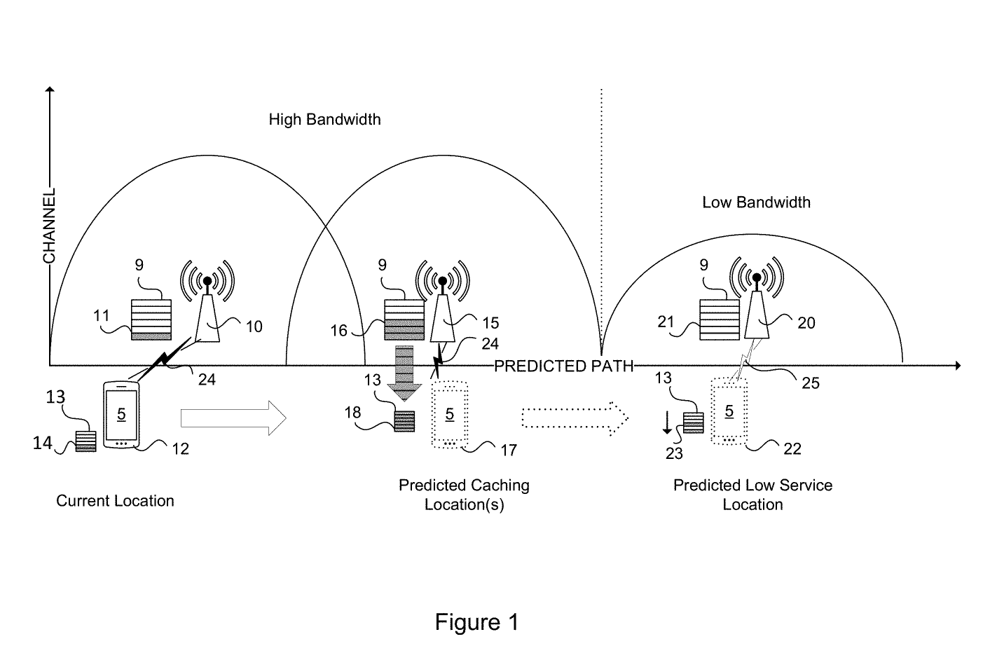

FIG. 1 is a simplified schematic illustrating an embodiment of pre-fetching data. A receiving UE 5 is located at a current location 12 and is connected to a radio access network (RAN) by a current access node (AN) 10 that provides connectivity within an area that includes the current location 12. In this example, the current location 12 has a high bandwidth connection 24 between the UE 5 and the current AN 10. The current AN 10 includes an AN cache 9 and the UE 5 includes a UE cache 13. The AN cache 9 has a current location AN cache status 11 and the UE cache 13 has a current location UE cache status 14.

A pre-fetching network entity, not illustrated in FIG. 1, evaluates the data consumption demands of the UE 5 and generates a predicted data consumption for one or more time periods in the future. For instance, if the UE 5 is downloading video in segments (e.g. 10 seconds of video), the pre-fetching network entity can evaluate the downloading and determine that there is a predictable periodicity to future data consumption and download demands. The pre-fetching network entity generates a predicted future data consumption estimate which is indicative of probable future data consumption based on the recent past demands of the UE 5.

The pre-fetching network entity also takes as input information including the UE cache status 14, the Quality of Experience (QoE) of the user of the UE 5, current network status, and predicted future network status. The network status may include, for instance, user mobility, network loads, predicted network loads, network costs, and available network resources). In some aspects, the network status may further take into consideration predicted future locations of the UE 5 at future time periods, and the corresponding network resources available to serve the UE 5 at those predicted future locations.

In an aspect, the information may be pulled by the UE 5 or the RAN. In an aspect, the information may be pushed by the transmitting end point to the UE 5 and/or the RAN.

Based on the predicted future data consumption estimate, and the available/predicted network resources, the pre-fetching network entity makes a pre-fetching decision whether or not to pre-fetch data to one or more predicted caching location ANs 15 for caching on the cache associated with each of the one or more predicted caching location ANs 15. In FIG. 1, the pre-fetching network entity has determined that the UE 5 is likely moving to a predicted low service location 22 which is served by a predicted low service AN 20. The low service location 22 may result, for instance, from a channel condition such as backhaul or radio link congestion, low available bandwidth in the backhaul or radio link, insufficient network resources supporting the low service location 22, high demand, or other condition that may result in a lower QoE for the user of the UE 5. In some aspects, the low service location 22 may result, for instance, from a buffer or demand condition at either the low service AN or the UE 5. In these aspects, the channel may not be impaired, but may be insufficient to meet the demand, or replenish the buffer, as may be required within a timely enough fashion to maintain QoE. In some aspects, the low service location 22 may result, for instance, from a high connection or data transfer cost at the low service location 22. In these aspects, the channel and buffer may not be impaired, but it may be desirable for the UE 5 to pre-fetch sufficient content data to allow it to traverse through the low service location 22 with minimum connection to limit or avoid the connection or data transfer costs at that location.

A network resource metric is a quantifiable value that, alone or in combination, expresses whether a location is a low service location 22. The network resource metric may be applied to a current network condition, or may provide an estimate of a future network condition as may be predicted based upon a combination of current network conditions and historical network conditions. As an example, time-based data traffic patterns may predict network congestion at certain times of day in certain locations. These predictions may be used to determine whether or not to pre-fetch data to avoid a future low service location 22. As another example, historical mobility patterns may indicate that UEs 5 travelling along a certain path experience a low service location 22 at a particular point in the path (for instance travelling through poor coverage, or travelling into a tunnel). A UE 5 that is determined to be travelling along a current path that matches the historical mobility pattern may be predicted to be entering into a low service location 22 when it reaches the same point along the path.

Network resource metrics may constitute any measurable value that is shown through modelling to be correlated to low service events. For instance, a general QoE value assigned to a location may identify a low service location 22 if it falls below a threshold value. The QoE value may show a periodicity or predictability based upon an evaluation of historical data. Other examples of network resource metrics may include, for instance a buffer status, a mobility pattern (e.g. following a train line), a time of day at a specific location, a current network congestion measure, a current network resource measure, and a combination of current metrics and historical metric patterns.

The UE 5 is predicted to be served by a low-bandwidth connection 25 in the predicted low service location 22, and accordingly would not be able to receive sufficient data to maintain the user's QoE. The low-bandwidth connection 25 is by way of example only, and the predicted low service location 22 may result from a network condition such as a lack of network resource availability to the predicted low service location 22, a higher cost connection, network congestion, or other network condition that may reduce the user's QoE.

With the determination that the UE 5 is likely moving to the predicted low service location 22 and would be unable to maintain the user's QoE at the predicted low service location 22, the pre-fetching network entity evaluates the predicted path and pre-fetches data to one or more predicted caching ANs 15 at one or more predicted caching locations 17. The pre-fetching network entity selects between the one or more predicted caching locations 17 based upon a likelihood that the UE 5 will connect to the RAN through each of the corresponding one or more predicted caching location ANs 15 as well as the network resources available to serve the UE 5 at that predicted caching location 17. In some aspects, the one or more predicted caching locations 17 may each receive a same set of pre-fetched data, the pre-fetched data can be uncoded or encoded. If the pre-fetched data is encoded, for example by a fountain coding, the coded data in each caching location can be encoded differently so that the UE later can get some portion of coded data from different caches to recover the pre-fetched data. In some aspects, different sets of pre-fetched data may be pre-fetched at the one or more predicted caching locations 17, for instance where the pre-fetching is likely to occur over multiple predicted caching ANs 15.

In next generation networks the pre-fetching network entity may comprise the coordinated action of multiple network entities. For example, in proposed 5G networks, the pre-fetching network entity may comprise coordinated action between an access and mobility management entity (AMF), a session management entity (SMF), and a traffic engineering function (TEF). In some aspects, the SMF may comprise a part or all of the functions of the TEF.

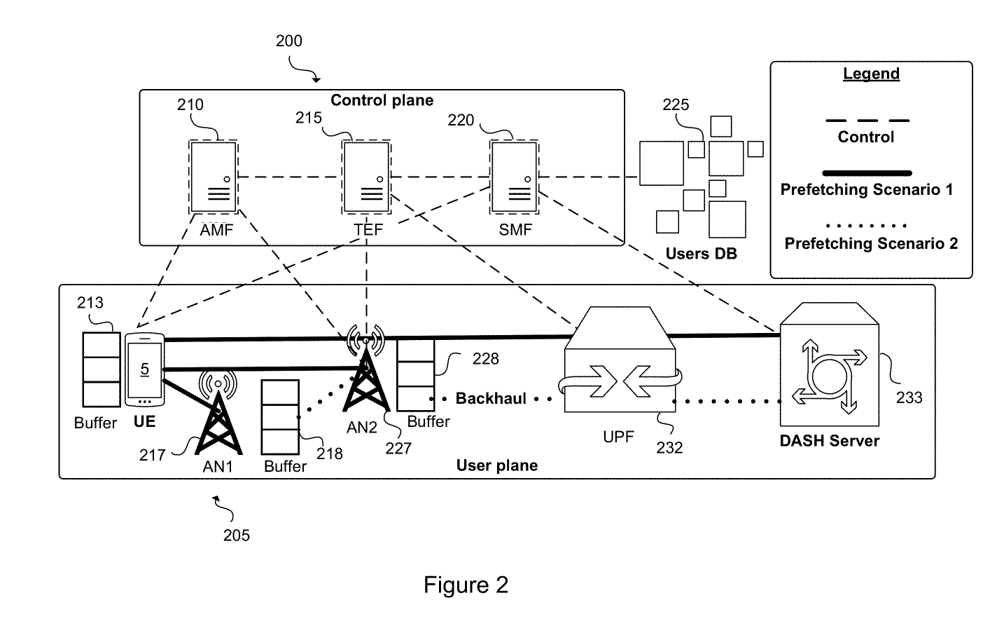

FIG. 2 is a simplified network schematic illustrating an embodiment of a system for pre-fetching data. In the example, a control plane (CP) 200 connects to a users' DB 225 and provides control over network resources of a user plan (UP) 205. The CP 200 includes one or more network entities that are collectively operative to provide pre-fetching operations. In the example of FIG. 2, the CP 200 includes the AMF 210, TEF 215, and SMF 220. The UP 205 includes a representative UE 5 and associated UE buffer 213 in communication with a RAN. The RAN includes a first AN 217 and associated first AN buffer 218, and a second AN 227 and associated second AN buffer 228. The first AN 217 and the second AN 227 are connected through a backhaul connection to a User Plane Function (UPF) 232, which connects to a transmitting endpoint such as the exemplar Dynamic Adaptive Streaming over HTTP (DASH) server 233 included in FIG. 2.

The AMF 210 maintains a mobility context of each UE 5 connecting to the RAN, and predicts future mobility patterns, locations and handovers between ANs. The SMF 220 interacts with the UE 5 and the receiving endpoints, such as the DASH server 233, to coordinate data exchanges such as video segment transmissions from the transmitting endpoint to the UE 5 to maintain the communication session. The TEF 215 interacts with the various network resources, the AMF 210, and the SMF 220 to predict future data transmission rates for UEs 5 from the transmitting end point to each UE 5. The data transmission rates may be segmented by backhaul, and wireless connections. The users' DB 225 maintains historic information of data consumption by UEs 15 and network traffic and resource availability. The historic information may be pushed from the users' DB 225 to the network entities, or may be pulled from the users' DB 225 by the network entities on demand as required.

It will be understood that the AMF 210 may, in addition to predicting future mobility patterns, provide predictions of future UE locations, handovers and mobility patterns as a service within the network. Other network functions, and possibly entities outside the core network, or outside the core network control plane, may subscribe to such services, or may request such services through a service based interface of the AMF. In one example, the service based interface used for these requests may be the Namf interface. In other embodiments, the TEF 215 may interact with the AMF 210 and SMF 220 to participate in providing predicted future data transmission rates as a network service. The predictions of future data transmission rates may be provided on a per-UE basis for UEs specified by the entity requesting the service. In other embodiments, predictions may be provided for a group of UEs that share a common characteristic (e.g. a set of UEs that have a common mobility pattern, for example a group of UEs that are all on the same train).

FIG. 2 includes two pre-fetching scenarios: scenario 1—pre-fetching to the UE buffer 217, and scenario 2—pre-fetching to the AN buffers 218, 228. A third pre-fetching scenario may include a hybrid of the two pre-fetching scenarios, where data is pre-fetched to the AN buffers 218, 228 and then the pre-fetched data is transmitted from the AN buffers 218, 228 to the UE buffer 213.

The pre-fetching operations may be driven by different entities in the network. For instance, the pre-fetching may be a UE-driven pre-fetching operation, or alternatively the pre-fetching may be a RAN-driven pre-fetching operation.

In the case of a UE-driven pre-fetching operation (Option 1: O1), 8 UE pre-fetching schemes may be provided, for example:
Type 1 (O1-T1): SM-assisted UE Pull data from DASH servers.
Type 2 (O1-T2): SM-instructed UE Pull data from DASH servers.
Type 3 (O1-T3): SM-assisted Server Push Data to UE.
Type 4 (O1-T4): SM-instructed Server Push Data to UE.
Type 5 (O1-T5): SM-assisted UE Pull data from RAN. (contents have been prefetched at the RAN)
Type 6 (O1-T6): SM-instructed UE Pull data from RAN.
Type 7 (O1-T7): SM-assisted RAN Push Data to UE.
Type 8 (O1-T8): SM-instructed RAN Push Data to UE.

In the case of a RAN-driven pre-fetching operation (Option 2:)2), 8 RAN pre-fetching schemes may be provided, for example:
Type 1 (O2-T1): SM-assisted RAN Pull data from DASH servers.
Type 2 (O2-T2): SM-instructed RAN Pull data from DASH servers.
Type 3 (O2-T3): SM-assisted Server Push Data to RAN.
Type 4 (O2-T4): SM-instructed Server Push Data to RAN.
Type 5 (O2-T5): SM-assisted RAN Pull data from other RANs. (contents have been prefetched at the RAN)
Type 6 (O2-T6): SM-instructed RAN Pull data from other RANs.
Type 7 (O2-T7): SM-assisted RAN Push Data to other RANs.
Type 8 (O2-T8): SM-instructed RAN Push Data to other RANs.

Pre-fetching Mechanisms may include, for instance:
Pull types
   UEs and/or RANs are equipped with pre-fetching functions that can receive the pre-fetching request from the SMF and pull data from the transmitting end point.
   RAN pull: requesting data is available for RANs
Push types
   SMF is operative to send data REQs to transmitting end points (e.g. data servers) or RANs directly.
SM-assisted types
   SMF provides REQs and the related information to UEs or RANs.
   Decisions are made by UEs and RANs whether to pre-fetch based upon local content demand and/or local data traffic.
SM-instructed types
   UEs and RANs follow instructions received from the SMF without discretion.
   SMF makes the decisions and sends the information of specific content or portions of content (e.g. video segments) that need to be pre-fetched by the UE or the RAN, as the case may be.
Data source
   Data may be sourced from the transmitting end point (e.g. content server) when content is “new”.
   Data may be sourced from the associated AN or other ANs when the content has already been pre-fetched (and buffered) at the ANs.

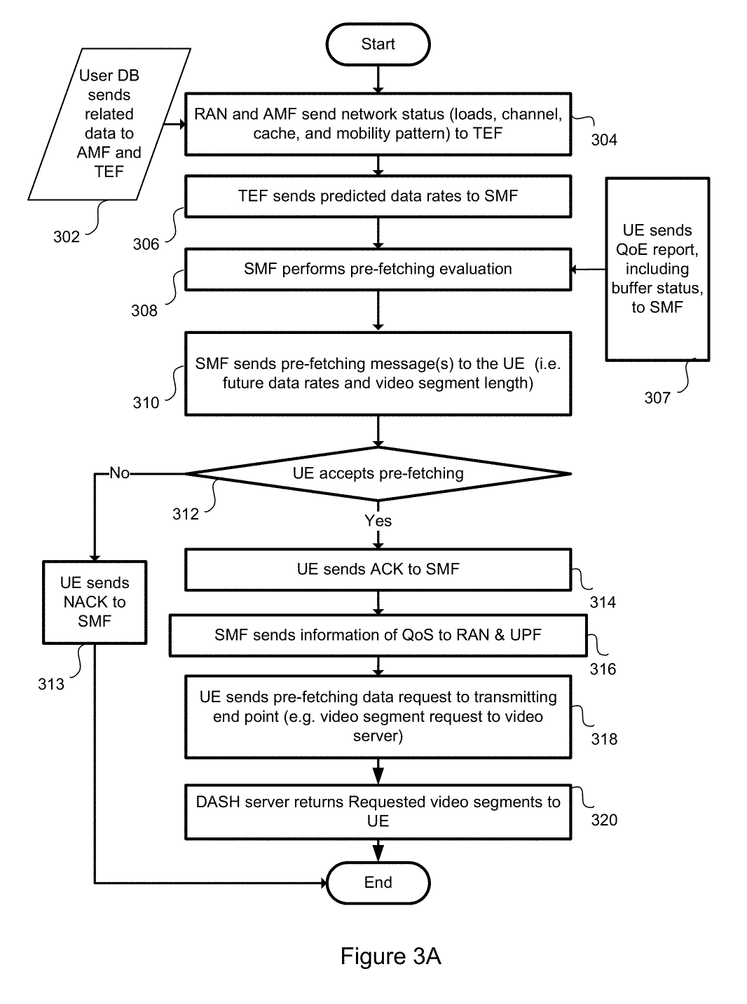

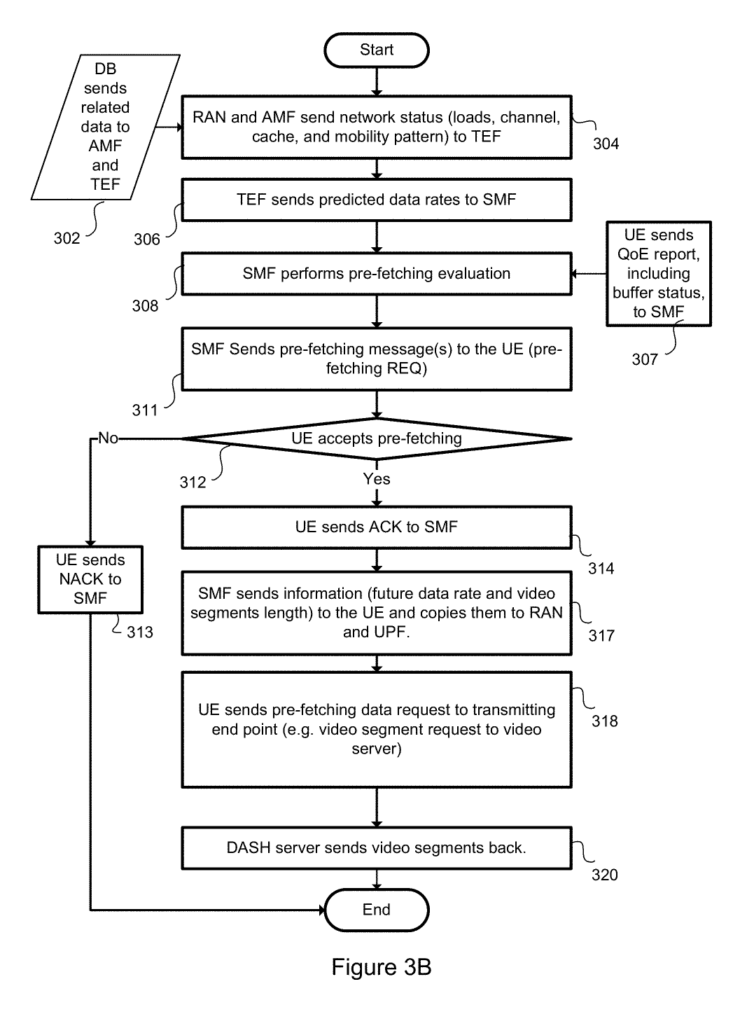

FIGS. 3A and 3B are process flow charts illustrating embodiments of call flows for Option 1: UE-driven pre-fetching. The call flows refer to different entities “sending” information, but it is understood that this includes both pushed data and pulled data, depending upon the implementation. Referring to FIG. 3A, in an initial phase the network entities exchange relevant information to allow the SMF 220 to make a pre-fetching evaluation. In step 304 the RAN and the AMF 220 send network status information (network loads, channel information, cache status, and mobility patterns) to the TEF 215. In step 302 the users' DB 225 sends historic information (e.g. UE data consumption, network traffic, and resource availability) to the AMF 210 and the TEF 215. In step 306 the TEF 215 generates a predicted future network resource estimation (e.g. predicted available future data rates as experienced by the UE 5 in the predicted future location(s)), and provided the predicted future network resource estimation to the SMF 220. In step 307 the SMF 220 also receives a QoE report sent by the UE 5, including an indication of a current status of the UE buffer 13. In step 308 the SMF 220 performs a pre-fetching evaluation using the UE 5 QoE report, UE buffer status, and predicted future network resource estimation. In step 310 the SMF 220 transmits at least one pre-fetching message to the UE 5. In an aspect, the at least one pre-fetching message may include pre-fetching data, including for instance, the predicted/estimated future data rates and/or video segment lengths where relevant. In step 312 the UE 5 determines whether it will accept data pre-fetching based upon the pre-fetching messages received from the SMF 220 and UE state information. The UE state information may include, for instance, UE buffer status, received user input, or other relevant UE state information. If the UE 5 determines that it does not accept pre-fetching, in step 313 the UE 5 sends a negative acknowledgement to the SMF 220 informing the SMF 220 that it does not support pre-fetching at this time. If the UE 5 determines that it does accept pre-fetching, in step 314 the UE 5 sends a positive acknowledgement to the SMF 220 that it does support pre-fetching at this time. In response to receiving the positive acknowledgement, in step 316 the SMF 220 sends QoS information to the RAN and the UPF 232. In step 318, in the case of the data being a video file, the UE 5 selects the video segments having bit rate matching to the supported data rate notified in step 310 and sends a pre-fetching data request to a transmitting end point, such as video segment request to a video server (e.g. DASH server 233 in FIG. 2). In step 320, the transmitting end point returns the requested pre-fetched data. Referring to FIG. 3A, the transmitting end point comprises the video server (e.g. DASH server 233) which returns the requested video segments to the UE 5.

With reference to the above discussion, in some embodiments of such a method and system, the RAN nodes and the AMF 220 may send the network status information to the TEF 215 in response to a request (or a configuration set in response to receipt of a request) from other functions. In some embodiments, examples of other functions may include an SMF, the AMF, and another AMF. These other network functions (or functional entities) can request these services (e.g. any or all of the different types of predictions) from the AMF, and in some embodiments may do so using a service based interface such as the Namf interface.

In some embodiments, the DB may send information automatically (upon detection of a trigger) or periodically. The manner in which the DB sends information may be determined in accordance with a request that initialized the reporting. The DB may also send information in response to receipt of a request (e.g. a one off request). The requests from other network entities for a service from the DB may be send through a service based interface such as Nudm.

The TEF 215 may be involved in the generation of data for estimates of future resource availability (e.g. estimated future data rates). The TEF 215 may generate these estimates on its own, or it may provide information to another network function for use in the generation of such an estimate. In some embodiments, the TEF 215 may generate the estimates in response to a request from a network function such as SMF 220. The request for services such as prediction or the generation of an estimate may be received by TEF 215 over a service based interface such as Ntef.

In the above discussion, reference to video segment lengths may, in some embodiments, represent a duration during which UE 5 is expected to experience any or all of a service interruption, a reduced transfer rate and a high (or elevated) service cost). In some embodiments the video segment length may be a function of such a duration but not the duration itself. In some embodiments, the pre-fetching message sent from the SMF to the UE may include a duration during which the UE may experience at least one of high cost and low throughput, allowing the UE to determine how many video segments should be pre-fetched.

FIG. 3B illustrates an alternate embodiment of the process flow of FIG. 3A. In the alternate embodiment, steps 310 and 316 are replaced with alternate steps 311 and 317. In particular, in step 311 the SMF 220 transmits the at least one pre-fetching message to the UE 5, which includes a request only indicating the availability for pre-fetching data. In step 317, after receiving the acknowledgement from the UE 5, the SMF 220 returns pre-fetching information, including for instance the predicted/estimated future data rates and/or video segment lengths where relevant, and copies the pre-fetching information to the RAN and the UPF 232. Other than the alternate steps, the rest of the process flow of FIG. 3B matches the process flow of FIG. 3A.

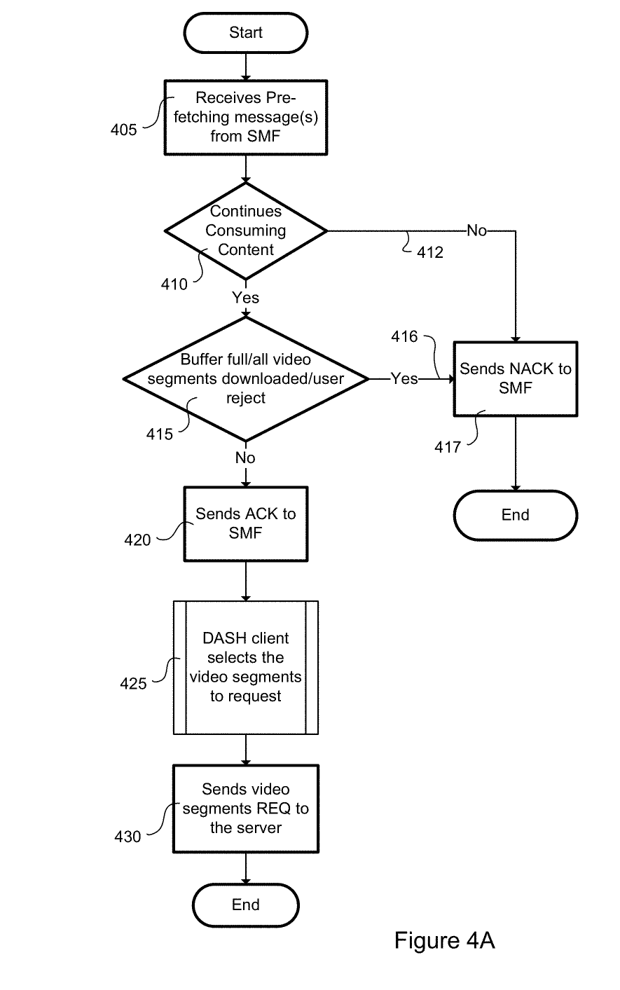

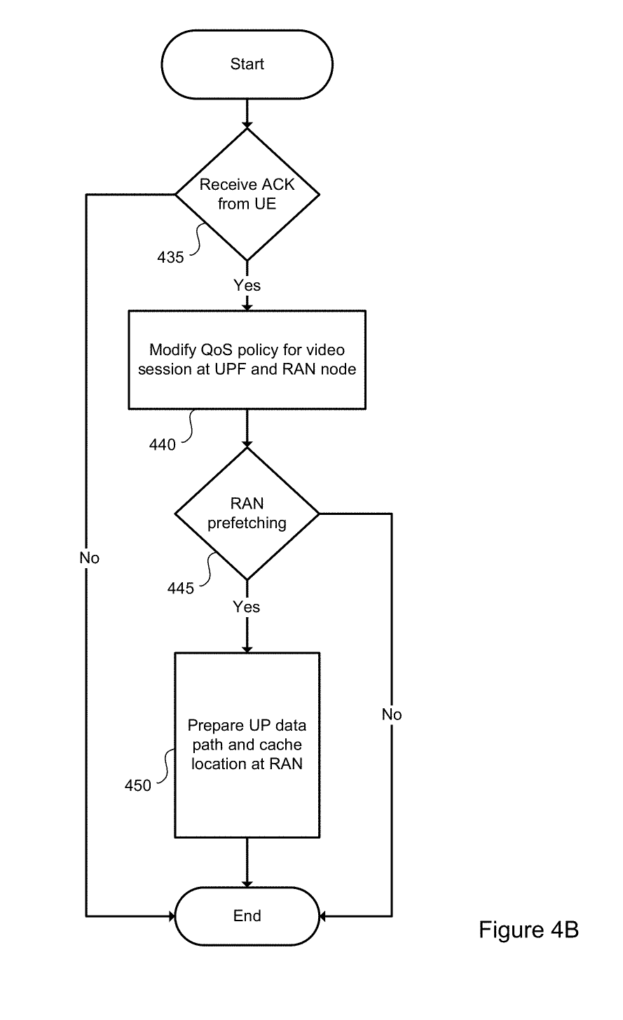

FIGS. 4A and 4B are process flow charts illustrating embodiments of a data pre-fetching method preformed by the UE 5 and the SMF 220 respectively. Referring to FIG. 4A, in step 405 the UE 5 received one or more pre-fetching messages from the SMF 220. In step 410, the UE 5 determines whether it needs to continue consuming the currently accessed content. For instance, where the content is a video the UE 5 may determine that the video file is nearly at an end. If the UE 5 determines in step 412 that it does not need to continue consuming content, it sends a negative acknowledgement to the SMF 220 in step 417.

If the UE 5 determines that it needs to continue consuming content, then in step 415 the UE 5 further determines whether it is available to pre-fetch data. The determination may include, for instance, evaluating a current state of the UE buffer to determine whether it is already full, evaluating the current content being downloaded to determine whether all segments have been downloaded, and prompting the user to provide user input indicating whether to accept or reject the pre-fetched data. If the UE 5 determines in step 416 that it is not available to pre-fetch data, then in step 417 the UE 5 sends a negative acknowledgement to the SMF 220. If the UE 5 determines that it is available to pre-fetch data, then in step 420 the UE 5 sends an acknowledgement to the SMF 220 confirming that it is able to pre-fetch data. In step 430 the UE 5, or a client operating on the UE 5 such as a DASH client, selects the content to pre-fetch (i.e. the number of video segments to pre-fetch, specific video segments with suitable data rate and suitable video quality), and in step 430 the UE 5, or the client operating on the UE 5, sends a pre-fetching data request to the transmitting end point identifying the content to be pre-fetched. For example, in the case of video content the UE 5 will send to the transmitting end point a pre-fetching data request identifying the video segments to be prefetched.

Referring to FIG. 4B, in step 435 the SMF 220 determines whether it has received a positive acknowledgement from the UE 5. If the SMF 220 either does not receive the acknowledgement, or receives a negative acknowledgement, then the pre-fetching procedure is terminated. If the SMF 220 receives the acknowledgement, then in step 440 the SMF 220 modifies the QoS policy for the video session at the UPF and the RAN node that is the anchor point for the UE 5. In step 445 the SMF 220 determines whether there will be RAN pre-fetching and caching, or UE pre-fetching and caching. If it is determined that there will be RAN pre-fetching, then in step 450 the SMF 220 prepares the UP data path and cache location at one or multiple RAN nodes. If it is determined that there will not be RAN pre-fetching, then the pre-fetching procedure at the SMF 220 is completed.

In some embodiments, the SMF may determine a set of potential serving RAN nodes. The nodes within this set may be any of the current serving AN nodes, handover target AN nodes, or AN nodes along a path associated with the mobility pattern of the UE. The SMF may then setup one or more UP data paths (including UPFs) to the RAN nodes in the set of potential serving RAN nodes. This can be done to facilitate the delivery of data requested by the UE in response to receipt of the pre-fetching message.

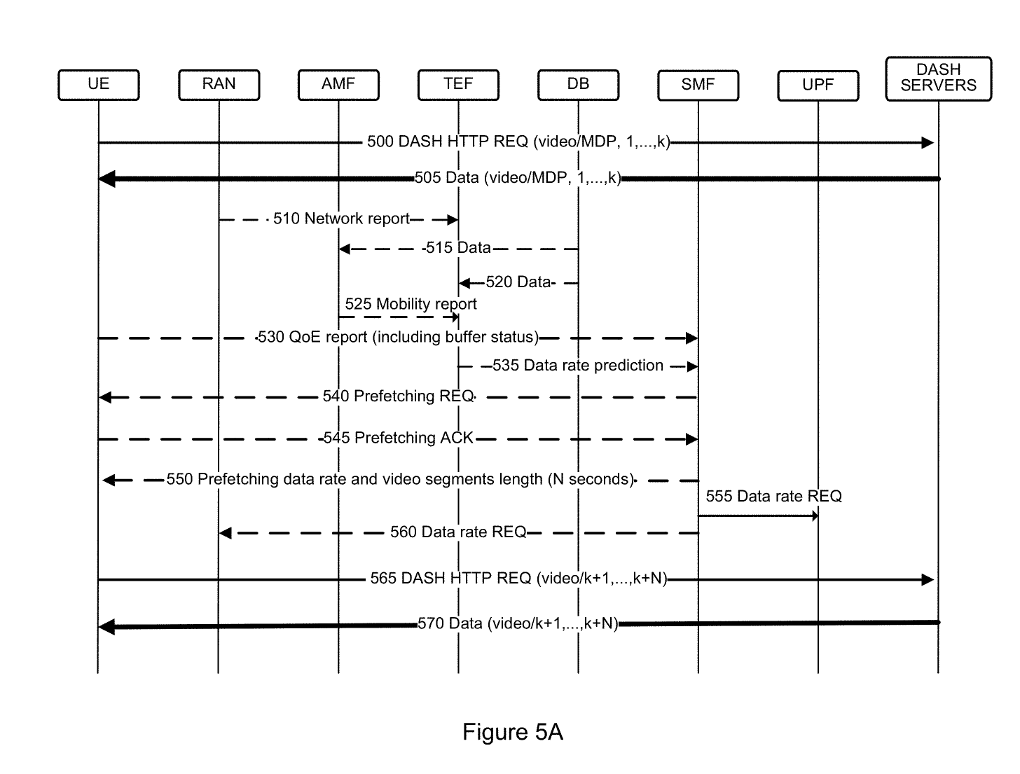

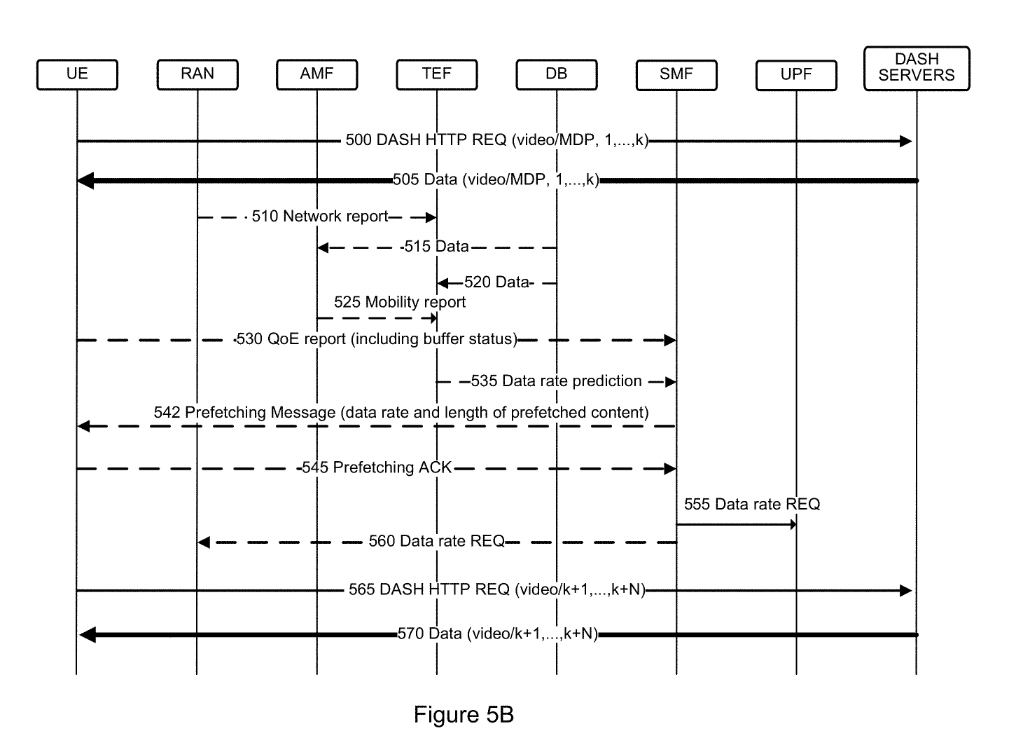

FIGS. 5A and 5B are signalling diagrams illustrating embodiments of a system performing a data pre-fetching method of SM-assisted data pulling by the UE 5 (Option 1—Type 1), where the content example is video provided by a DASH video protocol. Referring to FIG. 5A, in step 500 the UE 5 transmits a DASH HTTP Request identifying the video and including a media presentation description (i.e. MPD) which describes segment information such as timing, URL, and media characteristics (e.g. video resolution and bit rates) to the transmitting end point (i.e. a DASH server). In step 505 the transmitting end point transmits the requested content to the UE 5. In the specific example of FIG. 5A, the transmitting end point is a DASH server which transmits the requested video segments to the UE 5.

In step 510 TEF 215 receives network reports from the RAN. In step 515 the users' DB 225 provides user data to the AMF 210-, and in step 520 the users' DB 225 provides user data to TEF 215. In step 525, based at least in part upon the received user data, the AMF 210 transmits a mobility report to the TEF 215. In step 530 the UE 5 may transmit a QoE report, including UE buffer status, to the SMF 220. Based on the network report, user data, and mobility report, in step 535 TEF 215 transmits a data rate prediction to the SMF 220. The SMF 220 evaluates the QoE report and the data rate prediction, and may determine that pre-fetching is available and may be useful. With the determination, in step 540 the SMF 220 transmits a pre-fetching request to the UE 5. The UE 5 evaluates the pre-fetching request, and if it is determined to pre-fetch, in step 545 the UE 5 transmits a pre-fetching acknowledgement to the SMF 220. In step 550 the SMF 220 transmits pre-fetching information, such as the data rate and length of the video segments (e.g. a video segment comprises N seconds of video data). In step 555 the SMF 220 transmits a data rate request to the UPF 232. In step 560 the SMF 220 transmits a data rate request to the RAN. In step 565 the UE 5 transmits a pre-fetching data request (e.g. the DASH HTTP request in FIG. 5A) to the transmitting endpoint (e.g. the DASH server in FIG. 5A). The UE 5 may determine appropriate content parameters based upon the pre-fetching information received in step 550. For instance, in the example of video data, a UE client can determine suitable video quality to match the data rate and length of video segments as indicated/recommended in the pre-fetching information. The transmitting end point receives the pre-fetching data request and, in response, in step 570 the transmitting end point transmits requests pre-fetched data to the UE 5.

In some embodiments, the AMF 210 may send the mobility report based on he requests received from other functions (such as the SMF 220). These requests may be sent to the AMF 210 through a service based interface such as Namf. In some embodiments, the predictions of future data rates may be provided to the SMF 220 by the TEF, and may be provided in accordance with requests sent to the TEF by other network functions such as the SMF, through a service based interface.

FIG. 5B illustrates an alternate embodiment in which steps 540 and 550 are replaced with a single step 542. In this embodiment in step 542 the SMF 220 transmits a pre-fetching request to the UE 5 that comprises a pre-fetching message including the pre-fetching information. In this alternate embodiment, the UE 5 receives the pre-fetching message, comprising a pre-fetching request and including the pre-fetching information. In step 545 the pre-fetching acknowledgement is transmitted to the SMF 220 based on the received pre-fetching message.

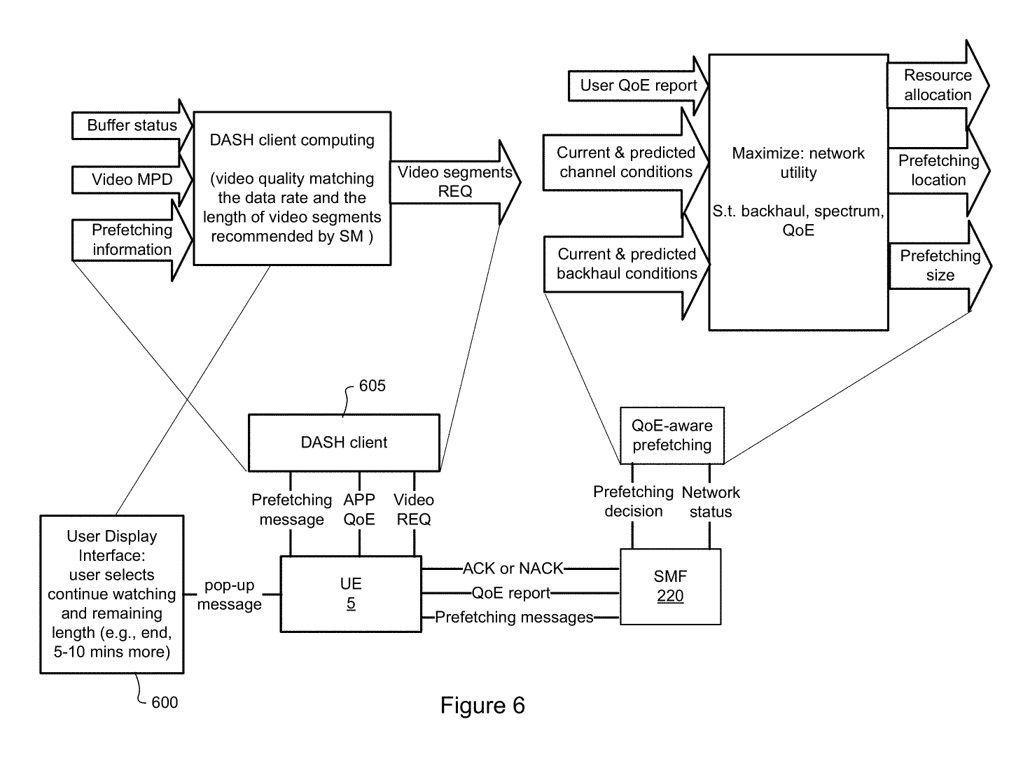

FIG. 6 is a simplified schematic of a system operative to pre-fetch data. The system of FIG. 6 is based on the above described pre-fetching methods. As illustrated the UE 5 includes a user display interface 600 and a content application for consuming content (such as the DASH client 605) included in this example. The UE 5 is in communication with the SMF 220 available on a connected network. The UE 5 is operative to receive from the SMF 220 pre-fetching messages, and to send to the SMF 220 QoE reports, pre-fetching request acknowledgements, and pre-fetching request negative acknowledgements. In this embodiment, the UE 5 includes a DASH client 605 for handling video data transmitted to the UE 5 from a DASH server as the transmitting end point. The DASH client 605 is operative to exchange with the UE 5 the pre-fetching message(s), application/content QoE, and content requests such as the video request indicated in FIG. 6. Pre-fetching operation of the DASH client 605 includes taking as input UE buffer status, video MPD (as provided in the pre-fetching message, for instance), and pre-fetching information. The DASH client 605 is operative to determine a video quality that matches the indicated data rate and length of video segments indicated/recommended by the SMF 220 and communicated in the pre-fetching message(s). Based on the determined video quality, the DASH client 605 is further operative to generate and output the video segments request to the UE 5 for communication to the SMF 220.

The user display interface 600 may present a user selection message to a user of the UE 5, such as a pop-up message as indicated in FIG. 6. The user selection message prompts the user to provide content consumption information to enable the UE 5 to determine whether data pre-fetching is required. For instance, the user display interface may present a user selection message that asks the user to select whether or not to continue consuming content (e.g. watching video), and if so the remaining length (e.g. end, specified time period such as 5-10 minutes more, etc.). Based on the user selection received in response to the user selection message, the DASH client 605 can determine the video segment request.

The SMF 220, or a network entity in communication with the SMF 220, may assess both the QoE report provided by the UE 5 in combination with an evaluation of available, and predicted, network resources (i.e. network status including current and predicted channel conditions and current and predicted backhaul conditions) to produce a pre-fetching decision. The pre-fetching decision may be directed to maximize network utility, backhaul utilization, spectrum utilization, and QoE. As an output, the pre-fetching decision may determine network resource allocation, identify one or more pre-fetching locations, and the size of the pre-fetched data at each location.

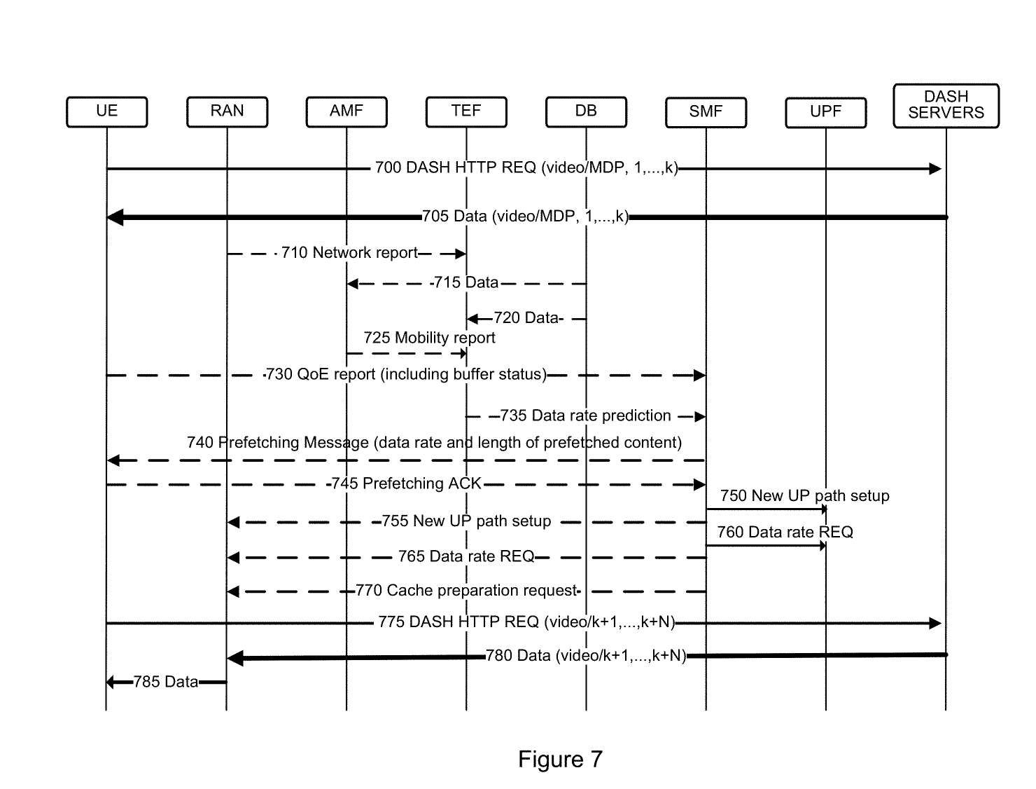

FIG. 7 is a signalling diagram illustrating an embodiment of a system performing a data pre-fetching method for SM-assisted data pulling to the RAN (Option 2—Type 1), where the content example is video provided by a DASH video protocol. Referring to FIG. 5A, in step 700 the UE 5 transmits a DASH HTTP Request identifying the video and including a media presentation description (i.e. MPD) which describes segment information such as timing, URL, and media characteristics (e.g. video resolution and bit rates) to the transmitting end point (i.e. a DASH server). In step 705 the transmitting end point transmits the requested content to the UE 5. In the specific example of FIG. 5A, the transmitting end point is a DASH server which transmits the requested video segments to the UE 5.

In step 710 TEF 215 receives network reports from the RAN. In step 715 the users' DB 225 provides user data to the AMF 210, and in step 720 the users' DB 225 provides user data to TEF 215. In step 725, based at least in part upon the received user data, the AMF 210 transmits a mobility report to the TEF 215. In step 730 the UE 5 may transmit a QoE report, including UE buffer status, to the SMF 220. Based on the network report, user data, and mobility report, in step 735 TEF 215 transmits a data rate prediction to the SMF 220. The SMF 220 evaluates the QoE report and the data rate prediction, and may determine that pre-fetching is available and may be useful. In step 740 the SMF 220 transmits a pre-fetching request to the UE 5 that comprises a pre-fetching message including the pre-fetching information, such as the data rate and length of the video segments (e.g. a video segment comprises N seconds of video data). The UE 5 receives the pre-fetching message, comprising a pre-fetching request and including the pre-fetching information. In step 745 the UE 5 generates and transmits a pre-fetching acknowledgement to the SMF 220 based on the received pre-fetching message. In step 750 the SMF 220 transmits new UP path setup information to the UPF 232. In step 755, the SMF 220 transmits the new UP path setup information to the RAN. The new UP path setup may include, for instance, the AN node of the RAN to receive the pre-fetched data as well as the new UP path to the selected node. In step 760, the SMF 220 transmits a data rate request to the UPF 232. In step 765 the SMF 220 transmits a data rate request to the RAN. The data rate requests may include, for instance an updated QoS policy in the from of QoS modify messages to set new QoS parameters of the pre-fetched data. In the case of video, the new QoS parameters may include, for instance, video flow parameters including maximum bitrate (MBR) for enforcement by QoS enforcement functions operative on the network. In step 770 the SMF 220 transmits a cache preparation request to the selected node of the RAN. In step 775 the UE 5 transmits a pre-fetching data request (e.g. the DASH HTTP request in FIG. 7) to the transmitting endpoint (e.g. the DASH server in FIG. 7). The UE 5 may determine appropriate content parameters based upon the pre-fetching information received in step 740. For instance, in the example of video data, a UE client can determine suitable video quality to match the data rate and length of video segments as indicated/recommended in the pre-fetching information. The transmitting end point receives the pre-fetching data request and, in response, in step 780 the transmitting end point transmits requests pre-fetched data to the RAN for caching. In step 785 the cached pre-fetched data is transmitted from the RAN to the UE 5.

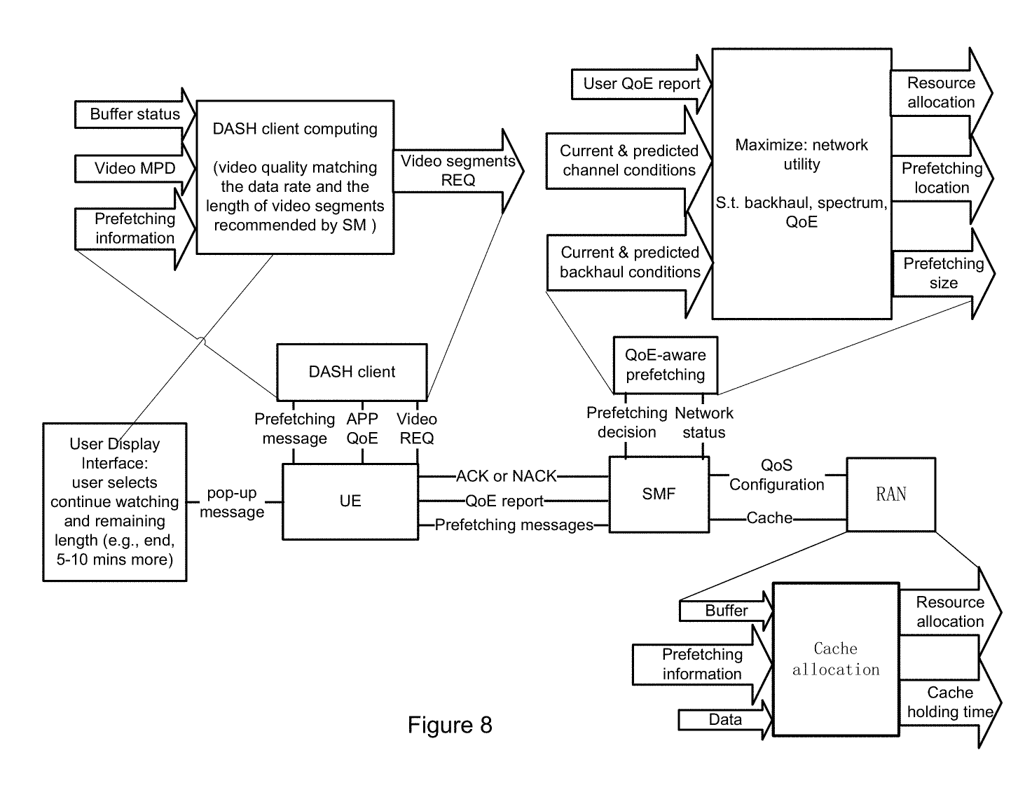

FIG. 8 is a simplified schematic of a system operative to pre-fetch data to a selected node of the RAN. The system of FIG. 8 reproduces the system of FIG. 6, with the addition of the RAN including QoS configuration and Cache interconnections with the SMF 220. The RAN further includes the operability to receive the data rate request and the cache preparation request in order to carry out cache allocation functions. In particular, the RAN may take as input buffer status information, pre-fetching information, and pre-fetched data. Based on this input the RAN may perform cache allocation functions, and deliver as output a cache resource allocation, for instance at a selected AN node identified in the pre-fetching information, and a cache holding time identifying a duration for the pre-fetched data to remain resident on the allocated cache before deletion if the pre-fetched data is not retrieved by the UE 5.

### Example—Simulation

A simulation was conducted to illustrate operation of data-prefetching. In the example, the simulation included the following parameters:

Flow level simulation
# of users=120, # of ANs=10
BandWidth of Spectrum=10 MHz, Tx Power=46 dBm, Backhaul (per AN)=50 Mbps
Mobility: 1-D line with average speed 55 kph
Video consuming bandwidth=[1,3] Mbps
User buffer size=30 Mb (20 seconds video)
AN cache size (per user)=40 Mb (20 seconds video)
Non-prefetching cache size (per user)=2 Mb (1 seconds video)
Schemes evaluated:
   UE pre-fetching: O1-T1 (from the server) and O1-T5 (from RAN)
   RAN pre-fetching: O2-T1 (from the server) and O2-T5 (from RAN)

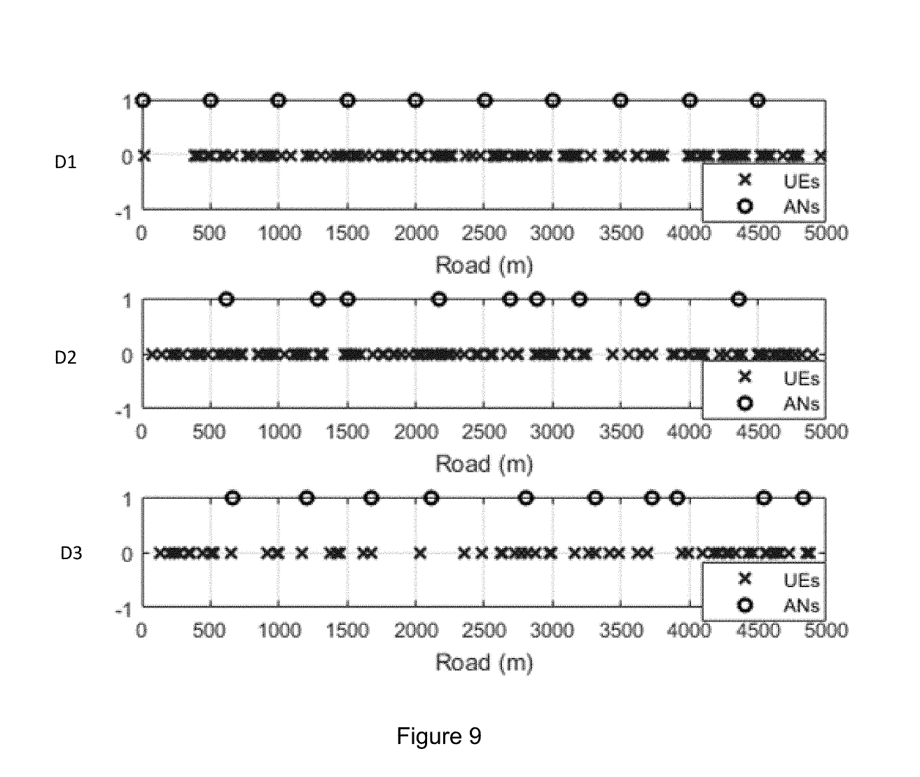

FIG. 9 illustrates 3 UE and AN distribution scenarios for an example simulation. The three distribution scenarios assume: D1) equal AN spacing and uniform UE distribution; D2) uniform UE distribution and uniform AN distribution; and, D3) grouped UE distribution and uniform AN distribution.

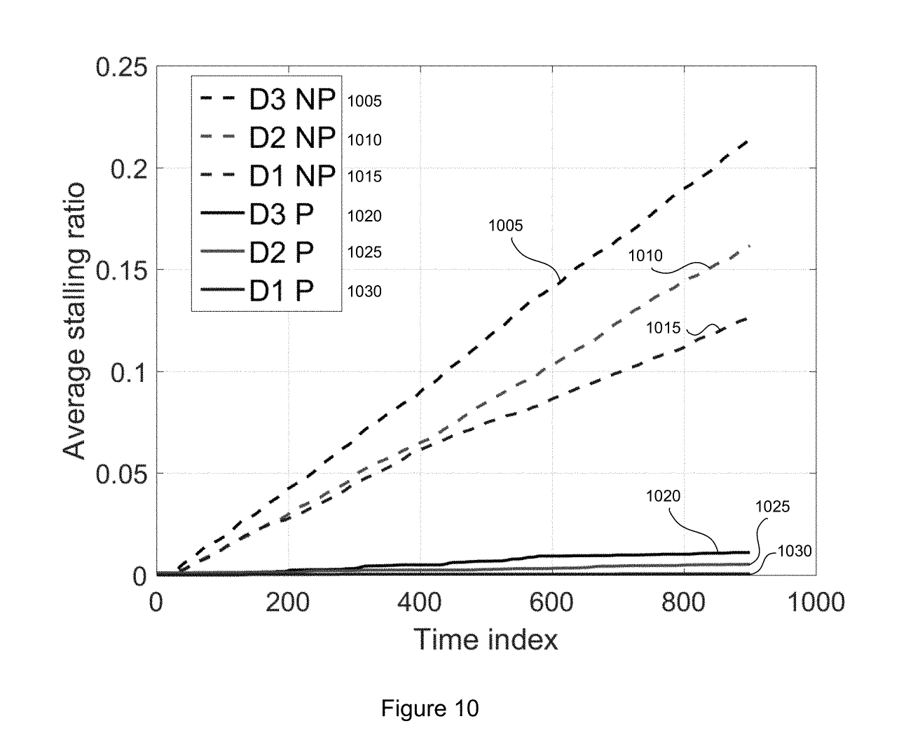

FIG. 10 illustrates simulation results for the 3 scenarios illustrated in FIG. 9. The plots illustrating simulation results for each of the three distributions with no pre-fetching 1005, 1010, 1015 have a higher average stalling ratio than the simulation result plots for the three distributions with pre-fetching 1020, 1025, 1030. Based on these results, it was determined that pre-fetching data is effective in all three scenarios D1, D2, and D3.

### Example—Pre-Fetching Decision Algorithm

The decision to implement pre-fetching may be based upon a number of factors. By way of example, a decision algorithm may be used to allocate backhaul links, spectrum, caching, and buffers based upon current and/or predicted network resource availability. For example, a decision algorithm may be defined as:

### Definition

Algorithm cycle length T (seconds).
   The scheduling is run every T (seconds) which is the estimation period.
Each user can associated to one or more APs for data transmission based on a pre-defined policy (e.g. Max-SINR or bia-SINR). The set of users that associate to the AP j is [symbol]
The backhaul link capacity for AP j is Lⱼ (bps)
The available spectrum capacity for the AP j is Wⱼ (Hz)
   The radio access and backhaul data rate for the user I at time t is rᵢ^{[t]} (bps) and iᵢ^{[t]} (bps)
   The predicted radio access and backhaul data rate for the user I after T is rᵢ^{[t+T]} (bps) and Iᵢ^{[t+T]} (bps).
The content utilizing rate (e.g. video playback rate) is pᵢ (bps).
The total cache capacity for the AP j is C̅ⱼ (Mbits).
   The total cache capacity for the user i is B̅ᵢ (Mbits).

The buffer and cache status at a particular time T may be determined by tracking current buffer/cache status, and including a predicted buffer/cache data input and a predicted buffer/cache predicted output to produce a predicted future buffer/cache status. For instance:

### Buffer Status

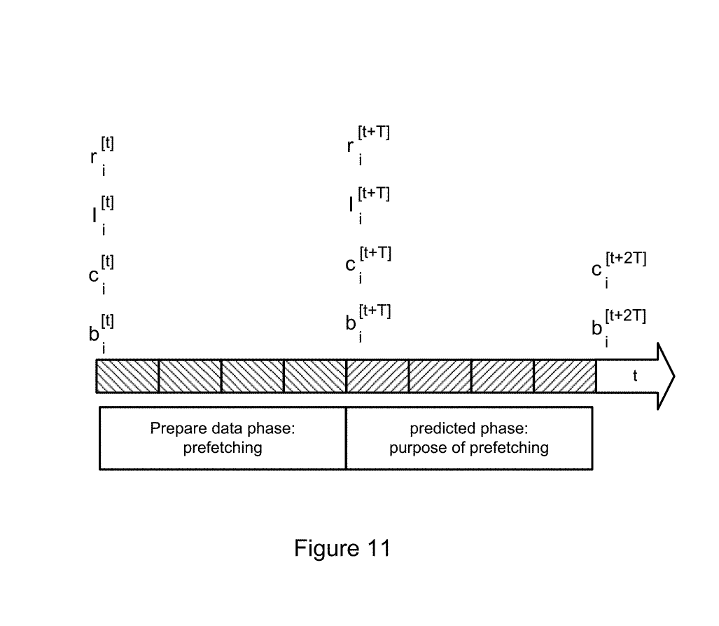

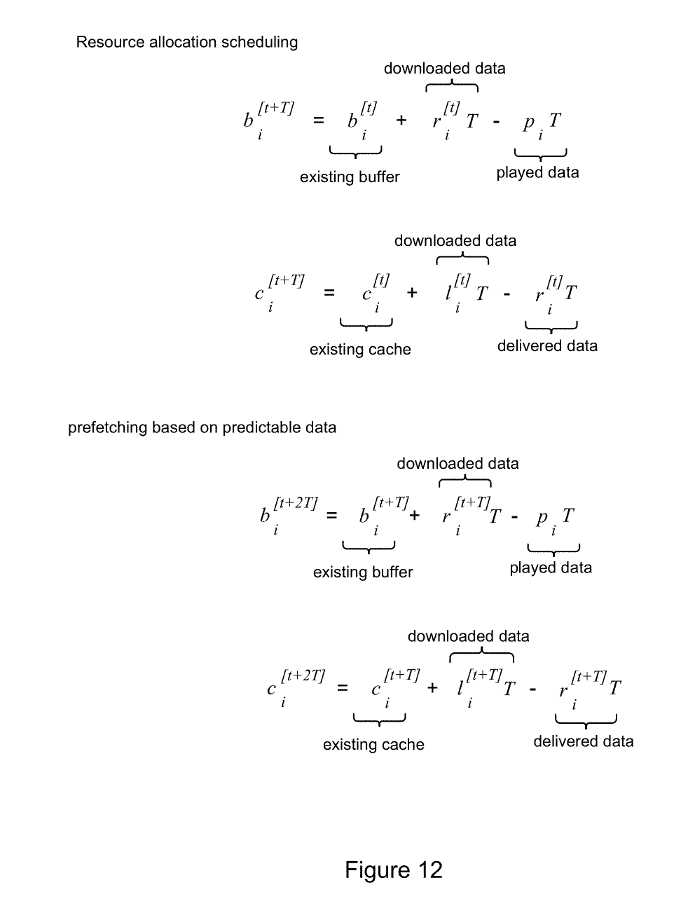

Referring to FIGS. 11 and 12, the buffers and caches at the beginning of the time [t] are denoted as bᵢ^{[t]} (Mbits) and cᵢ^{[t]} (Mbits). The buffers and caches after T are denoted as bᵢ^{[t+T]} (Mbits) and cᵢ^{[t+T]} (Mbits). The buffers and caches after 2T are shown as bᵢ^{[t+2T]} and cᵢ^{[t+2T]} FIG. 11 illustrates this nomenclature. FIG. 12 illustrates relationships for resource allocation scheduling and prefetching based on predictable data.

The objective of the pre-fetching decision is to maximize overall network utility, for instance to maximize throughput, streamed video quality (e.g. Mean Opinion Score—MOS), and to minimize stalling or network congestion. Infrastructure limitations may be modelled, for instance as:
Variables
   RAN access rate rᵢ^{[t]}
   Backhaul transmission rate lᵢ^{[t]}
Constrains
   Non-negativity of variables.
   Backhaul limitations.

$${\sum }_{i ∈ {I}_{j}^{[ t ]}} {l}_{i}^{[ t ]} \leq {L}_{j} , ∀ j , t$$

Spectrum limitations.

$${\sum }_{i ∈ {I}_{j}^{[ t ]}} \frac{{r}_{i}^{[ t ]}}{{γ}_{i}^{[ t ]}} \leq {W}_{j} , ∀ j , t$$

Cache storage limitations.

$${\sum }_{i ∈ {I}_{j}^{[ t + T ]}} {c}_{i}^{[ t + T ]} \leq {C}_{j}$$

$${\sum }_{i ∈ {I}_{j}^{[ t + 2 T ]}} {c}_{i}^{[ t + 2 T ]} \leq {C}_{j}$$

Users buffer limitations.

bᵢ^{[t+T]}pᵢ≤Bᵢ

bᵢ^{[t+2T]}pᵢ≤Bᵢ
Prefetching requirements.

cᵢ^{[t+2T]}≥Cᵢ

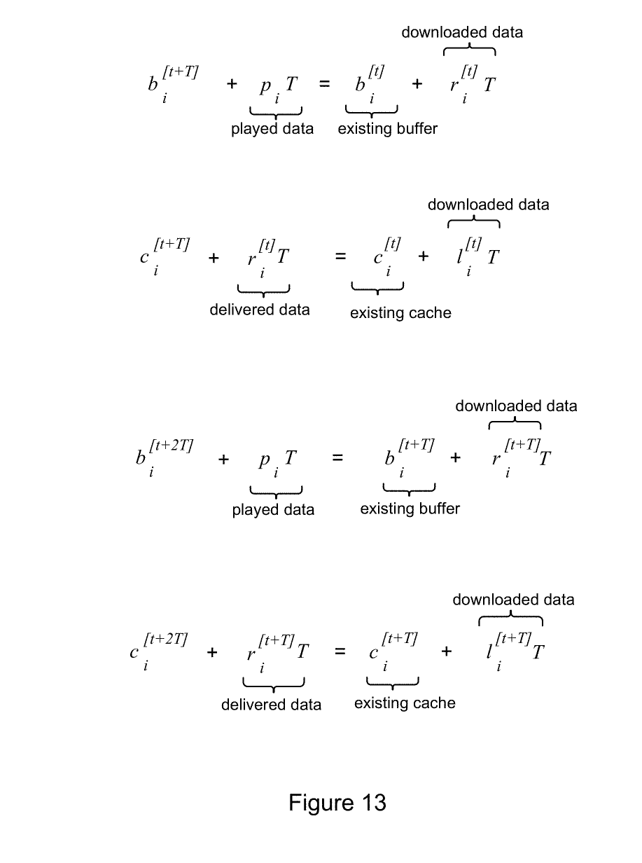

bᵢ^{[t+2T]}pᵢ≥Bᵢ
The flow conservation law (traffic engineering), as illustrated in FIG. 13.

The resulting problem may be expressed as a convex (linear) problem that may be solved in polynomial time.

Based on the foregoing description, it may be appreciated that aspects of the present invention may provide at least some of the following features:
A communication system operative to pre-fetch content for delivery to a UE connected to a communication network, the system comprising:
   at least one network entity operative to evaluate at least one network resource metric measuring an operating condition of the communication network, and operative to send a pre-fetching message to trigger pre-fetching of the content.
In some embodiments, the at least one network resource metric comprises a future predicted network resource metric.
In some embodiments, the future predicted network resource metric comprises a future predicted available bandwidth of a data link connecting the UE to the communication network.
In some embodiments, the data link comprises a backhaul link connecting an AN predicted to connect the UE to the communication network at a future time.
In some embodiments, the pre-fetching message is sent to the AN.
In some embodiments, the pre-fetching message is sent to a second AN predicted to connect the UE to the communication network before the future time.
In some embodiments, the second AN is predicted to have a backhaul link with a higher available bandwidth than the first AN.
In some embodiments, the data link comprises a wireless data link provided by an AN predicted to connect the UE to the communications network at a future time.
In some embodiments, the pre-fetching message is sent to the AN.
In some embodiments, the pre-fetching message is sent to a second AN predicted to connect the UE to the communication network before the future time.
In some embodiments, the second AN is predicted to have a wireless data link with a higher available bandwidth than the first AN.
In some embodiments, the pre-fetching message comprises a recommendation to pre-fetch data.
In some embodiments, the pre-fetching message comprises an instruction to pre-fetch data.
In some embodiments, the pre-fetching message is sent to the UE.
In some embodiments, the evaluation comprises considering:
   Predicted future UE location and handover to connect to the communication network;
   Predicted future available data bandwidth on communication network data links connecting the UE to a transmitting endpoint providing the content; and,
   Predicted future buffer/cache status available to receive the pre-fetched data.
A communication system operative to pre-fetch content for delivery to a UE connected to a communication network, the system comprising:
   at least one network entity operative to evaluate at least one network resource metric measuring an operating condition of the communication network, and operative to send to a UE connected to the network a pre-fetching message to trigger pre-fetching of the content.
In some embodiments, the system further comprises:
   the UE operative to receive the pre-fetching message and to send a pre-fetching request to the communication network based on the pre-fetching message.
In some embodiments, the pre-fetching request is directed to pre-fetch content to an access node currently connected to the UE.
In some embodiments, the pre-fetching request is directed to pre-fetch content to an access node predicted to connect the UE in the future based on the UE's current mobility pattern.
In some embodiments, the pre-fetching message comprises a recommendation that the UE pre-fetch content.
In some embodiments, the pre-fetching message comprises an instruction that the UE pre-fetch content.
In some embodiments, the UE is further operative to evaluate a UE buffer status and to send the pre-fetching request based on the pre-fetching message and the UE buffer status.

Although the present invention has been described with reference to specific features and embodiments thereof, it is evident that various modifications and combinations can be made thereto without departing from the invention. The specification and drawings are, accordingly, to be regarded simply as an illustration, and the scope of claims are as defined by the appended claims, and are contemplated to cover any and all modifications, variations, combinations or equivalents that fall within their scope.

We claim:

1. A method for execution at a User Equipment (UE) comprising:
receiving, at the UE, a pre-fetching message indicative of an estimated future data rate associated with the UE; and
transmitting, from the UE, a pre-fetching acknowledgment.

2. The method of claim 1 further comprising transmitting, from the UE, a pre-fetching data request towards a transmitting endpoint.

3. The method of claim 2 wherein the transmitting endpoint comprises a video server associated with an active video session.

4. The method of claim 3 wherein the pre-fetching data request is a Dynamic Adaptive Streaming over HTTP (DASH) compliant request for a video segment.

5. The method of claim 4 wherein the requested video segments are determined by the UE in accordance with the estimated future data rate and information received by the UE about available video segments.

6. The method of claim 4 wherein the video segment has an encoding quality selected in accordance with the estimated future data rate.

7. The method of claim 1 wherein transmitting the pre-fetching acknowledgment is performed at least partially responsive to a UE-based determination that additional video content can be cached.

8. The method of claim 1 wherein the pre-fetching message is received from a Session Management Function (SMF).

9. The method of claim 8 wherein the pre-fetching acknowledgment is transmitted towards the SMF.

10. The method of claim 8 further comprising transmitting, towards the SMF, a buffer status report.

11. The method of claim 10 wherein transmitting the buffer status report comprises transmitting a Quality of Experience report including the buffer status, towards the SMF before receiving the prefetching message.

12. A User Equipment (UE) comprising:
at least one processor;
a non-transitory computer readable storage medium including software instructions configured to control the at least one processor to implement steps of:
receiving, at the UE, a pre-fetching message indicative of an estimated future data rate associated with the UE; and
transmitting, from the UE, a pre-fetching acknowledgment.

13. The UE of claim 12 further comprising software instructions configured to control the at least one processor to implement a step of transmitting, from the UE, a pre-fetching data request towards a transmitting endpoint.

14. The UE of claim 13 wherein the transmitting endpoint comprises a video server associated with an active video session.

15. The UE of claim 14 wherein the pre-fetching data request is a Dynamic Adaptive Streaming over HTTP (DASH) compliant request for a video segment.

16. The UE of claim 15 wherein the requested video segments are determined by the UE in accordance with the estimated future data rate and information received by the UE about available video segments

17. The UE of claim 15 wherein the video segment has an encoding quality selected in accordance with the estimated future data rate.

18. The UE of claim 12 wherein transmitting the pre-fetching acknowledgment is performed at least partially responsive to a UE-based determination that additional video content can be cached.

19. The UE of claim 12 wherein the pre-fetching message is received from a Session Management Function (SMF).

20. The UE of claim 19 wherein the pre-fetching acknowledgment is transmitted towards the SMF.

21. The UE of claim 19 further comprising transmitting, towards the SMF, a buffer status report.

22. The UE of claim 21 wherein transmitting the buffer status report comprises transmitting a Quality of Experience report including the buffer status, towards the SMF before receiving the prefetching message.

23. A method for execution at a control plane function comprising:
transmitting, towards a user equipment, a prefetching message comprising future data rates; and
receiving from the user equipment, a prefetching acknowledgement message.

24. The method of claim 23 wherein the control plane function is a Session Management Function.

25. The method of claim 23 further comprising, after receiving the prefetching acknowledgement message, transmitting towards at least one of user plane functions and radio access network nodes, instructions to setup a user plane data path.
